(19) United States
(12) Patent Application Publication
(10) Pub. No.: US 2020/0301898 A1
(43) Pub. Date: Sep. 24, 2020

(54) SYSTEMS AND METHODS FOR ACCELERATING DATA OPERATIONS BY UTILIZING DATAFLOW SUBGRAPH TEMPLATES

(71) Applicant: BigStream Solutions, Inc., Mountain View, CA (US)

(72) Inventors: Balavinayagam Samynathan, Mountain View, CA (US); Keith Chapman, Los Altos, CA (US); Mehdi Nik, Sunnyvale, CA (US); Behnam Robatmili, San Jose, CA (US); Shahrzad Mirkhani, Los Altos, CA (US); Maysam Lavasani, Los Altos, CA (US); John David Davis, San Francisco, CA (US); Danesh Tavana, Los Altos, CA (US); Weiwei Chen, Mountain View, CA (US)

(73) Assignee: BigStream Solutions, Inc., Mountain View, CA (US)

(21) Appl. No.: 16/898,048

(22) Filed: Jun. 10, 2020

Related U.S. Application Data
(63) Continuation-in-part of application No. 16/452,046, filed on Jun. 25, 2019.
(60) Provisional application No. 62/859,651, filed on Jun. 10, 2019.
(60) Provisional application No. 62/689,754, filed on Jun. 25, 2018.

(51) Int. Cl. G06F 16/21; G06F 16/25; G06N 5/04

(52) U.S. Cl. CPC G06F 16/217; G06N 5/04; G06F 16/254

(57) ABSTRACT

Methods and systems are disclosed for accelerating Big Data operations by utilizing subgraph templates for a hardware accelerator of a computational storage device. In one example, a computer-implemented method comprises performing a query with a dataflow compiler, performing a stage acceleration analyzer function including executing a matching algorithm to determine similarities between sub-graphs of an application program and unique templates from an available library of templates; and selecting at least one template that at least partially matches the sub-graphs with the at least one template being associated with a linear set of operators to be executed sequentially within a stage of the Big Data operations.

### RELATED APPLICATIONS

This application claims the benefit of U.S. Provisional application Ser. No. 62/859,651, filed on Jun. 10, 2019, the entire contents of this Provisional application is hereby incorporated by reference. This application is a continuation-in-part of U.S. Non-Provisional application Ser. No. 16/452,046, filed on Jun. 25, 2019, which claims the benefit of U.S. Provisional application Ser. No. 62/689,754, filed on Jun. 25, 2018, the entire contents of these applications are hereby incorporated by reference.

### TECHNICAL FIELD

Embodiments described herein generally relate to the field of data processing, and more particularly relates to methods and systems for accelerating big data operations by utilizing subgraph templates.

### BACKGROUND

Conventionally, big data is a term for data sets that are so large or complex that traditional data processing applications are not sufficient. Challenges of large data sets include analysis, capture, data curation, search, sharing, storage, transfer, visualization, querying, updating, and information privacy.

### SUMMARY

For one embodiment of the present invention, methods and systems for accelerating Big Data operations by utilizing subgraph templates are disclosed. In one embodiment, methods and systems are disclosed for accelerating big data operations by utilizing subgraph templates. In one example, a data processing system includes a hardware processor and a hardware accelerator coupled to the hardware processor. The hardware accelerator is configured with a compiler of an accelerator functionality to generate an execution plan, to generate computations for nodes including subgraphs in a distributed system for an application program based on the execution plan, and to execute a matching algorithm to determine similarities between the subgraphs and unique templates from an available library of templates.

In one example, a computer-implemented method comprises performing a query with a dataflow compiler, performing a stage acceleration analyzer function including executing a matching algorithm to determine similarities between sub-graphs of an application program and unique templates from an available library of templates; and selecting at least one template that at least partially matches the sub-graphs with the at least one template being associated with a linear set of operators to be executed sequentially within a stage of the Big Data operations.

Other features and advantages of embodiments of the present invention will be apparent from the accompanying drawings and from the detailed description that follows below.

### BRIEF DESCRIPTION OF THE DRAWINGS

FIG. 1 shows an embodiment of a block diagram of a big data system 100 for providing big data applications for a plurality of devices in accordance with one embodiment.

FIG. 2 is a flow diagram illustrating a method 200 for accelerating big data operations by utilizing subgraph templates according to an embodiment of the disclosure.

FIG. 3 is a flow diagram illustrating a method 300 for runtime flow of big data operations by utilizing subgraph templates according to an embodiment of the disclosure.

FIG. 4 shows an embodiment of a block diagram of an accelerator architecture for accelerating big data operations by utilizing subgraph templates in accordance with one embodiment.

FIG. 5 illustrates the schematic diagram of a data processing system according to an embodiment of the present invention.

FIG. 6 illustrates the schematic diagram of a multi-layer accelerator according to an embodiment of the invention.

FIG. 7 is a diagram of a computer system including a data processing system according to an embodiment of the invention.

FIG. 8 illustrates the components of a storage device in accordance with one embodiment.

FIG. 9 illustrates software layers which facilitate using accelerators in Big Data applications seamlessly.

FIG. 10 shows a system 1000 having hyper-acceleration layers to accelerate queries (e.g., Spark queries) in accordance with one embodiment.

FIG. 11 is a flow diagram illustrating a method 1100 for accelerating big data operations according to an embodiment of the disclosure.

FIG. 12 illustrates first and second stages having different operators for Big Data operations.

FIG. 13 is a flow diagram illustrating a method 1300 for runtime flow of big data operations by utilizing subgraph templates according to an embodiment of the disclosure.

FIG. 14 illustrates logically the design components of a FPGA in accordance with one embodiment.

FIG. 15 shows an interface between software and hardware including API calls that abstract away device-specific drivers in accordance with one embodiment.

FIG. 16 compares performance of scan heavy TPC-DS queries between vanilla Spark 1610 and accelerated Spark 1620 of the present design in smart SSD for a single node.

FIG. 17 shows results for a 4 node cluster for vanilla Spark 1710 and accelerated Spark 1720 of the present design with each node having 100 GB of TPC-DS data totaling 400 GB for the cluster.

FIG. 18 shows an embodiment of a block diagram of an accelerator architecture for accelerating big data operations by utilizing subgraph templates in accordance with one embodiment.

### DETAILED DESCRIPTION OF EMBODIMENTS

Methods, systems and apparatuses for accelerating big data operations by utilizing subgraph templates are described.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

HW: Hardware.

SW: Software.

I/O: Input/Output.

DMA: Direct Memory Access.

CPU: Central Processing Unit.

FPGA: Field Programmable Gate Arrays.

CGRA: Coarse-Grain Reconfigurable Accelerators.

GPGPU: General-Purpose Graphical Processing Units.

MLWC: Many Light-weight Cores.

ASIC: Application Specific Integrated Circuit.

PCIe: Peripheral Component Interconnect express.

CDFG: Control and Data-Flow Graph.

FIFO: First In, First Out

NIC: Network Interface Card

HLS: High-Level Synthesis

KPN: Kahn Processing Networks (KPN) is a distributed model of computation (MoC) in which a group of deterministic sequential processes are communicating through unbounded FIFO channels. The process network exhibits deterministic behavior that does not depend on various computation or communication delays. A KPN can be mapped onto any accelerator (e.g., FPGA based platform) for embodiments described herein.

Dataflow analysis: An analysis performed by a compiler on the CDFG of the program to determine dependencies between a write operation on a variable and the consequent operations which might be dependent on the written operation.

Accelerator: a specialized HW/SW component that is customized to run an application or a class of applications efficiently.

In-line accelerator: An accelerator for I/O-intensive applications that can send and receive data without CPU involvement. If an in-line accelerator cannot finish the processing of an input data, it passes the data to the CPU for further processing.

Bailout: The process of transitioning the computation associated with an input from an in-line accelerator to a general purpose instruction-based processor (i.e. general purpose core).

Continuation: A kind of bailout that causes the CPU to continue the execution of an input data on an accelerator right after the bailout point.

Rollback: A kind of bailout that causes the CPU to restart the execution of an input data on an accelerator from the beginning or some other known location with related recovery data like a checkpoint.

Gorilla++: A programming model and language with both dataflow and shared-memory constructs as well as a toolset that generates HW/SW from a Gorilla++ description.

GDF: Gorilla dataflow (the execution model of Gorilla++).

GDF node: A building block of a GDF design that receives an input, may apply a computation kernel on the input, and generates corresponding outputs. A GDF design consists of multiple GDF nodes. A GDF node may be realized as a hardware module or a software thread or a hybrid component. Multiple nodes may be realized on the same virtualized hardware module or on a same virtualized software thread.

Engine: A special kind of component such as GDF that contains computation.

Infrastructure component: Memory, synchronization, and communication components.

Computation kernel: The computation that is applied to all input data elements in an engine.

Data state: A set of memory elements that contains the current state of computation in a Gorilla program.

Control State: A pointer to the current state in a state machine, stage in a pipeline, or instruction in a program associated to an engine.

Dataflow token: Components input/output data elements.

Kernel operation: An atomic unit of computation in a kernel. There might not be a one to one mapping between kernel operations and the corresponding realizations as states in a state machine, stages in a pipeline, or instructions running on a general purpose instruction-based processor.

Accelerators can be used for many big data systems that are built from a pipeline of subsystems including data collection and logging layers, a Messaging layer, a Data ingestion layer, a Data enrichment layer, a Data store layer, and an Intelligent extraction layer. Usually data collection and logging layer are done on many distributed nodes. Messaging layers are also distributed. However, ingestion, enrichment, storing, and intelligent extraction happen at the central or semi-central systems. In many cases, ingestions and enrichments need a significant amount of data processing. However, large quantities of data need to be transferred from event producers, distributed data collection and logging layers and messaging layers to the central systems for data processing.

Examples of data collection and logging layers are web servers that are recording website visits by a plurality of users. Other examples include sensors that record a measurement (e.g., temperature, pressure) or security devices that record special packet transfer events. Examples of a messaging layer include a simple copying of the logs, or using more sophisticated messaging systems (e.g., Kafka, Nifi). Examples of ingestion layers include extract, transform, load (ETL) tools that refer to a process in a database usage and particularly in data warehousing. These ETL tools extract data from data sources, transform the data for storing in a proper format or structure for the purposes of querying and analysis, and load the data into a final target (e.g., database, data store, data warehouse). An example of a data enrichment layer is adding geographical information or user data through databases or key value stores. A data store layer can be a simple file system or a database. An intelligent extraction layer usually uses machine learning algorithms to learn from past behavior to predict future behavior.

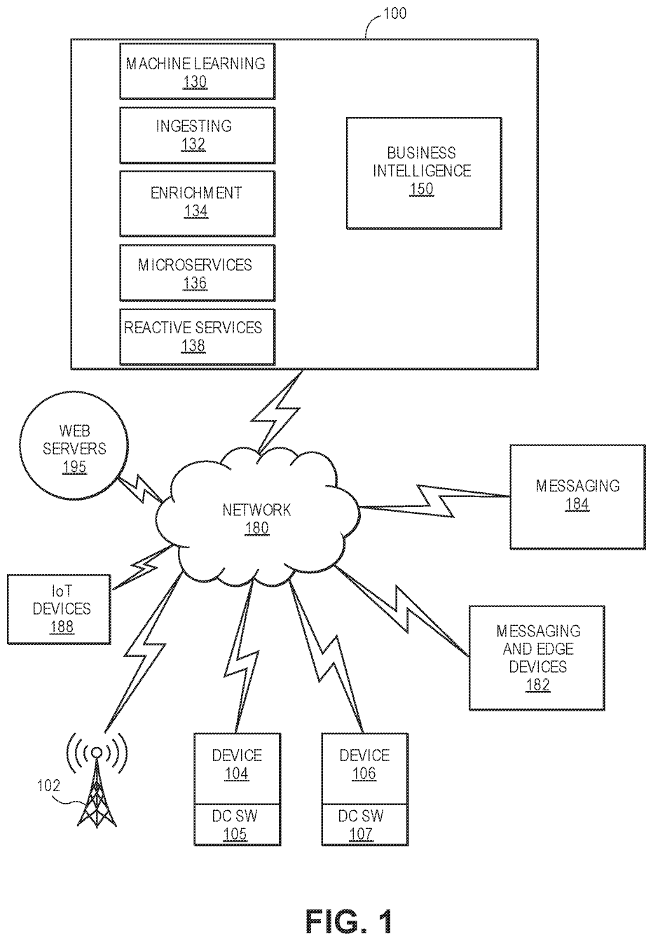

FIG. 1 shows an embodiment of a block diagram of a big data system 100 for providing big data applications for a plurality of devices in accordance with one embodiment. The big data system 100 includes machine learning modules 130, ingestion layer 132, enrichment layer 134, microservices 136 (e.g., microservice architecture), reactive services 138, and business intelligence layer 150. In one example, a microservice architecture is a method of developing software applications as a suite of independently deployable, small, modular services. Each service has a unique process and communicates through a lightweight mechanism. The system 100 provides big data services by collecting data from messaging systems 182 and edge devices, messaging systems 184, web servers 195, communication modules 102, internet of things (IoT) devices 186, and devices 104 and 106 (e.g., source device, client device, mobile phone, tablet device, lap top, computer, connected or hybrid television (TV), IPTV, Internet TV, Web TV, smart TV, satellite device, satellite TV, automobile, airplane, etc.). Each device may include a respective big data application 105, 107 (e.g., a data collecting software layer) for collecting any type of data that is associated with the device (e.g., user data, device type, network connection, display orientation, volume setting, language preference, location, web browsing data, transaction type, purchase data, etc.). The system 100, messaging systems and edge devices 182, messaging systems 184, web servers 195, communication modules 102, internet of things (IoT) devices 186, and devices 104 and 106 communicate via a network 180 (e.g., Internet, wide area network, cellular, WiFi, WiMax, satellite, etc.).

The present design automatically provides novel templates for performing frequently used functions (e.g., filter, project, join, map, sort) for common patterns in subgraphs of big data operations. In one example, a template includes multiple functions to reduce communications between a CPU and FPGA and also minimize or eliminate HLS. For example, a first template includes at least two of these functions (e.g., filter, project, inner/outer join, map, sort) and a second template includes at least three of these functions. These templates with multiple functions reduce a number of communications between CPU and FPGA in which the CPU sends data to the FPGA, programmable logic performs functionality, and then sends a result for each operand to the CPU.

A template of the present design (e.g., dataflow subgraph template) is a data structure with a link in which said link has a unique name with a pointer to a unique FPGA bitfile, core FPGA image, or GPU kernel. The bitfile or image has a circuit implementation for executing and accelerating a subgraph of an application program in FPGA hardware. The designated subgraph of the application program is obtained from a Directed Acyclic Graph (DAG) or a subset of DAG of typical distributed systems like Spark, and subsequently re-directed to an optimum execution unit like a CPU, FPGA, or GPU.

An FPGA accelerator hardware implementation can have functionality that is a superset (more) of the subgraph, an exact match or a subset of the subgraph. When it is a subset of the subgraph functionality, other computation units like the CPU and/or GPU complete the subgraph. When the hardware implementation has a superset of the subgraph, only the specific subset of the FPGA functions needed are used to complete the task. The optimal execution unit can be one or more of execution units for sequential or parallel execution.

Templates can further be customized based on run-time information about the workload. A single template can be reused for a variety of different applications that employ the same subgraph within an application. Templates are hardware bitfiles that are software configurable. These configurations or software personalities enable reuse across multiple applications.

In one embodiment, a template library is a collection of dataflow subgraph templates that are stored in a database or in another data structure. Certain set of subgraphs in a generic form is enough to execute a large number of real world applications. This library provides the ability to run majority of applications in distributed frameworks.

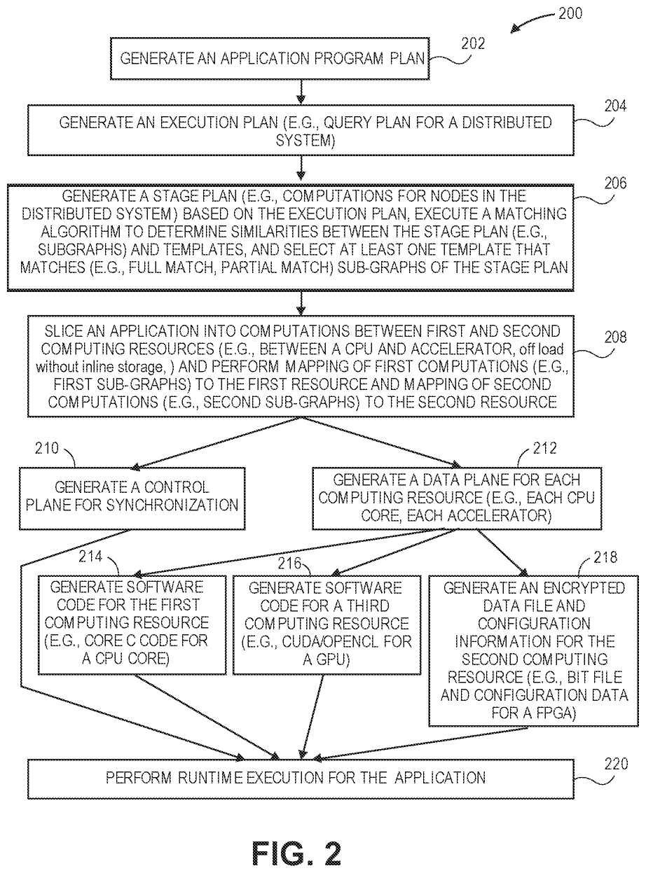

FIG. 2 is a flow diagram illustrating a method 200 for accelerating big data operations by utilizing subgraph templates according to an embodiment of the disclosure. Although the operations in the method 200 are shown in a particular order, the order of the actions can be modified. Thus, the illustrated embodiments can be performed in a different order, and some operations may be performed in parallel. Some of the operations listed in FIG. 2 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of method 200 may be executed by a compiler component, a data processing system, a machine, a server, a web appliance, a centralized system, a distributed node, or any system, which includes an in-line accelerator. The in-line accelerator may include hardware (circuitry, dedicated logic, etc.), software (such as is run on a general purpose computer system or a dedicated machine or a device), or a combination of both. In one embodiment, a compiler component performs the operations of method 200.

At operation 202, the method includes generating an application program plan. At operation 204, the method includes generating an execution plan (e.g., query plan for a distributed system). In one example, a distributed system (e.g., Spark) performs operations 202 and 204. At operation 206, the method generates a stage plan (e.g., computations for nodes in the distributed system) for the application program based on the execution plan, executes a matching algorithm to determine similarities between the stage plan (e.g., subgraphs) and unique templates from an available library of templates, and selects at least one template that matches (e.g., full match, partial match) sub-graphs of the stage plan. At operation 208, the method slices an application into computations between first and second computing resources (e.g., between a first execution unit and a second execution unit, between a CPU and in-line accelerator) and performs mapping of first computations (e.g., first subgraphs) to the first resource and mapping of second computations (e.g., second subgraphs) to the second resource. In one example of operation 208, a compiler generates a linear stage trace (LST) with a LST being a linear subgraph of the DAG or data-flow graph. The present design is not restricted to linear graphs and can operate on any kind of Directed Acyclic Graph (DAG). The compiler matches the stage plan to unique templates from an available library of templates, then generates FPGA, GPU and/or CPU specific control and data information for runtime execution flow by utilizing selected templates.

At operation 210, the method generates a control plan for synchronization. At operation 212, the method generates a data plane for each computing resource (e.g., each CPU core, each accelerator). At operation 214, the method generates software code for the first computing resource (e.g., core C code for a CPU core). At operation 216, the method generates software code for a third computing resource (e.g., CUDA/OpenCL for a GPU). At operation 218, the method generates an encrypted data file and configuration information for the second computing resource (e.g., BIT file and configuration data for a FPGA). At operation 220, the method performs runtime execution for the application (e.g., big data application). In one example, a data flow compiler may perform operations 206-218.

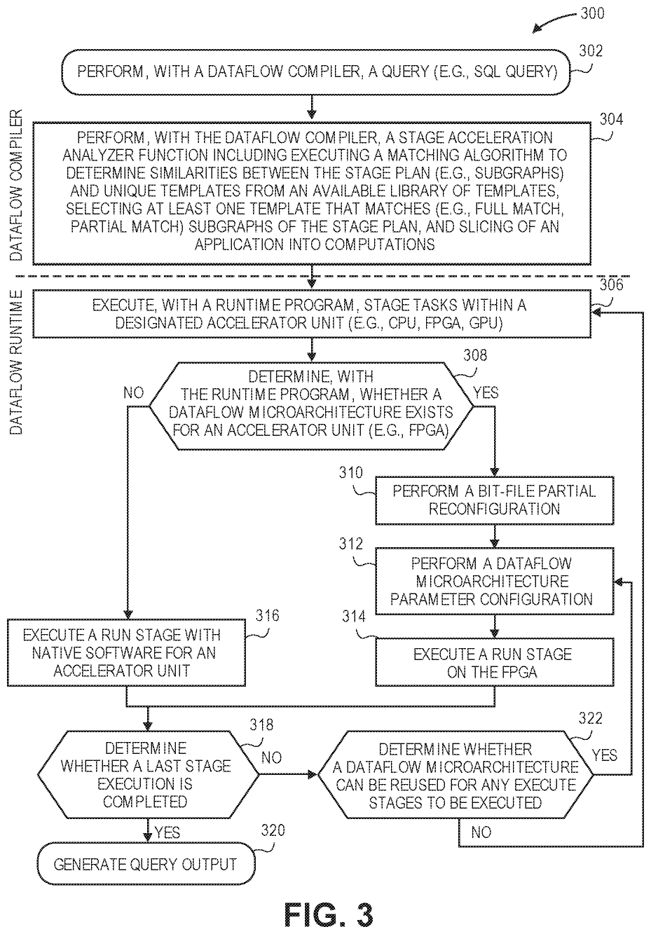

FIG. 3 is a flow diagram illustrating a method 300 for runtime flow of big data operations by utilizing subgraph templates according to an embodiment of the disclosure. Although the operations in the method 300 are shown in a particular order, the order of the actions can be modified. Thus, the illustrated embodiments can be performed in a different order, and some operations may be performed in parallel. Some of the operations listed in FIG. 3 are optional in accordance with certain embodiments. The numbering of the operations presented is for the sake of clarity and is not intended to prescribe an order of operations in which the various operations must occur. Additionally, operations from the various flows may be utilized in a variety of combinations.

Upon receiving FPGA, GPU or CPU specific control and data information from a data flow compiler of the present design, a runtime program executes the stage tasks inside the designated accelerator unit (e.g., CPU, FPGA, GPU) until the last stage is completed. The initial execution of an FPGA accelerated function within a stage requires bit-file partial reconfiguration (e.g., operation 310). This typically takes milliseconds. After the initial bit-file is downloaded, all subsequent application specific selectable parameters (e.g., filter values) are configured (e.g., operation 312) without requiring a bit-file partial reconfiguration. Parameter configurations or software personalities enable reuse across multiple applications. Data flow execution runs in a loop according to the control information until the last stage execution is completed.

At operation 302, a dataflow compiler performs a query (e.g., SQL query). At operation 304, dataflow compiler performs a stage acceleration analyzer function including executing a matching algorithm to determine similarities between the stage plan (e.g., sub-graphs) and unique templates from an available library of templates, selecting at least one template that matches (e.g., full match, partial match) sub-graphs of the stage plan, and slicing of an application into computations. At operation 306, a runtime program executes stage tasks within a designated accelerator unit (e.g., CPU, FPGA, GPU). At operation 308, the runtime program determines whether a dataflow microarchitecture exists for an accelerator unit (e.g., FPGA).

If so, then the runtime program performs a bit-file partial reconfiguration at operation 310. At operation 312, the runtime program performs a dataflow microarchitecture parameter configuration. At operation 314, the runtime program executes a run stage on the FPGA.

If no dataflow microarchitecture exists, then the runtime program executes a run stage with native software for an accelerator unit at operation 316. At operation 318, the runtime program determines whether a last stage execution is completed. If so, then the method proceeds to generate query output at operation 320. If not, then the method proceeds to determine whether a dataflow microarchitecture can be reused at operation 322 for any execute stages to be executed. If so, then the method proceeds to operation 312. If not, then the method returns to operation 306.

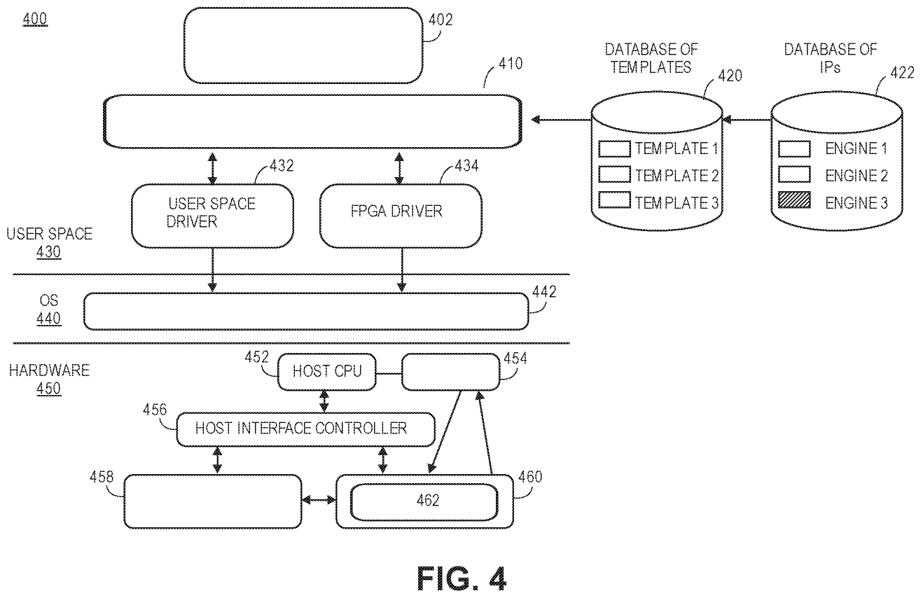

FIG. 4 shows an embodiment of a block diagram of an accelerator architecture for accelerating big data operations by utilizing subgraph templates in accordance with one embodiment. An accelerator architecture 400 (e.g., data processing system) includes an analytics engine 402 for large scale data processing, an acceleration functionality 410, a database of templates 420, and a database of intellectual property (IP) engines 422. A user space 430 includes an optional user space driver 432 (e.g., user space network adapter, user space file system) and a software driver 434 (e.g., FPGA driver). An operating system (OS) 440 includes a software driver 442 (e.g., NVMe/PCIe driver). Hardware 450 of the accelerator architecture includes a Host CPU 452, memory 454 (e.g., host DRAM), a host interface controller 456, a solid-state storage device 458, and an accelerator 460 (e.g., FPGA 460) having configurable design 462.

The accelerator architecture 400 provides an automated template discovery with creation and deployment methodology being used to provide additional templates and IP Engines (e.g., bitfiles) for an ever expanding database of template libraries.

In one example, a compiler component of acceleration functionality 410 identifies and loads FPGA bitstream based on an acceleration template match between an input subgraph and matching acceleration template of the database of templates 420.

The present design utilizes smart pattern matching from Application DAG to Hardware Templates with efficient cost functions. DAG template matching algorithms operate on a Directed Acyclic Graph that is typically used in distributed systems like SQL based analytic engines. The DAG template matching algorithms optimally assign the designated slices of the application program to a unique template within a library of templates. The algorithms utilize cost functions (e.g., performance, power, price, locality of data vs. accelerator, latency, bandwidth, data source, data size, operator selectivity based on sampling or history, data shape, etc. . . . ) to assign a slice of DAG to a template. Other standard cost functions can be system or user defined, and can be based on total stage runtime vs task run time. In such cases part of the graph will execute on the CPU, the rest on the accelerator.

Partial subgraph matches execute on an accelerator based on a cost function that optimizes the system and use either full or partial matches based on run time and historical information. A subgraph matches to a template. A template might include multiple engines. An engine can function as a generic operator or node in the graph. A subgraph might partially match with template. In such cases part of the graph will execute on the CPU, the rest on the accelerator.

Next, the acceleration functionality 410 performs a software configuration of a FPGA to customize a hardware template for an application. The acceleration functionality 410 then issues an “accelerated” compute task and this requires input/output requests to the device 458. Input data is copied from a host CPU 452 to memory of the FPGA 460 and back again to an application user space memory to complete this process for accelerating big data applications by utilizing acceleration templates.

Field software upgrades provide more operators and functionality enhancements to a current library of an accelerator. Feature discovery for new Engines and Templates happens by profiling the application and accumulating a history of profiles. Next, cost-based targeted optimization is used to realize the highest acceleration opportunities, followed by automated, offline template creation with automatic template library upgrades. Engines can be third party IP or internal IP. For 3rd party IP, the present design can meter to enable charge back.

An accelerator functionality 410 of the present design is agnostic to the specific physical locality of the FPGA within the overall system architecture. The accelerator functionality can be attached as an add-on card to the host server, embedded into the storage subsystem, or into the network interface, or it can be a remote server/client for near the edge IOT application.

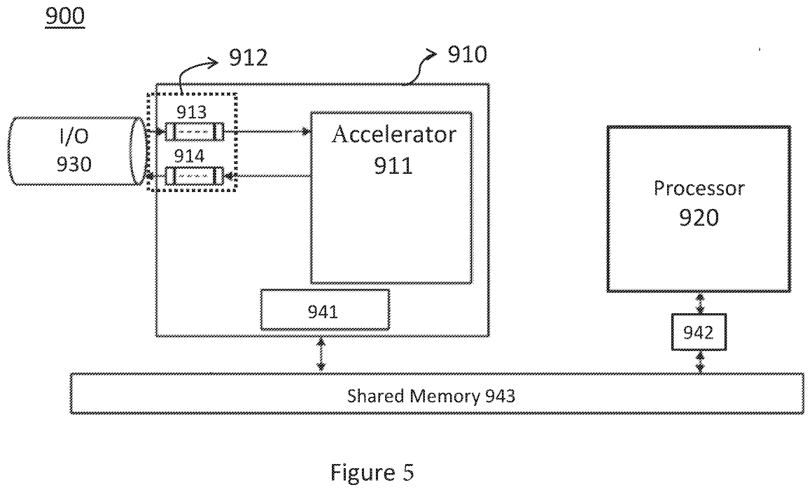

FIG. 5 illustrates the schematic diagram of data processing system 900 according to an embodiment of the present invention. Data processing system 900 includes I/O processing unit 910 and general purpose instruction-based processor 920. In an embodiment, general purpose instruction-based processor 920 may include a general purpose core or multiple general purpose cores. A general purpose core is not tied to or integrated with any particular algorithm. In an alternative embodiment, general purpose instruction-based processor 920 may be a specialized core. I/O processing unit 910 may include an accelerator 911 (e.g., in-line accelerator, offload accelerator for offloading processing from another computing resource, or both). In-line accelerators are a special class of accelerators that may be used for I/O intensive applications. Accelerator 911 and general purpose instruction-based processor may or may not be on a same chip. Accelerator 911 is coupled to I/O interface 912. Considering the type of input interface or input data, in one embodiment, the accelerator 911 may receive any type of network packets from a network 930 and an input network interface card (NIC). In another embodiment, the accelerator may be receiving raw images or videos from the input cameras. In an embodiment, accelerator 911 may also receive voice data from an input voice sensor device.

In an embodiment, accelerator 911 is coupled to multiple I/O interfaces (not shown in the figure). In an embodiment, input data elements are received by I/O interface 912 and the corresponding output data elements generated as the result of the system computation are sent out by I/O interface 912. In an embodiment, I/O data elements are directly passed to/from accelerator 911. In processing the input data elements, in an embodiment, accelerator 911 may be required to transfer the control to general purpose instruction-based processor 920. In an alternative embodiment, accelerator 911 completes execution without transferring the control to general purpose instruction-based processor 920. In an embodiment, accelerator 911 has a master role and general purpose instruction-based processor 920 has a slave role.

In an embodiment, accelerator 911 partially performs the computation associated with the input data elements and transfers the control to other accelerators or the main general purpose instruction-based processor in the system to complete the processing. The term “computation” as used herein may refer to any computer task processing including, but not limited to, any of arithmetic/logic operations, memory operations, I/O operations, and offloading part of the computation to other elements of the system such as general purpose instruction-based processors and accelerators. Accelerator 911 may transfer the control to general purpose instruction-based processor 920 to complete the computation. In an alternative embodiment, accelerator 911 performs the computation completely and passes the output data elements to I/O interface 912. In another embodiment, accelerator 911 does not perform any computation on the input data elements and only passes the data to general purpose instruction-based processor 920 for computation. In another embodiment, general purpose instruction-based processor 920 may have accelerator 911 to take control and completes the computation before sending the output data elements to the I/O interface 912.

In an embodiment, accelerator 911 may be implemented using any device known to be used as accelerator, including but not limited to field-programmable gate array (FPGA), Coarse-Grained Reconfigurable Architecture(CGRA), general-purpose computing on graphics processing unit (GPGPU), many light-weight cores (MLWC), network general purpose instruction-based processor, I/O general purpose instruction-based processor, and application-specific integrated circuit (ASIC). In an embodiment, I/O interface 912 may provide connectivity to other interfaces that may be used in networks, storages, cameras, or other user interface devices. I/O interface 912 may include receive first in first out (FIFO) storage 913 and transmit FIFO storage 914. FIFO storages 913 and 914 may be implemented using SRAM, flip-flops, latches or any other suitable form of storage. The input packets are fed to the accelerator through receive FIFO storage 913 and the generated packets are sent over the network by the accelerator and/or general purpose instruction-based processor through transmit FIFO storage 914.

In an embodiment, I/O processing unit 910 may be Network Interface Card (NIC). In an embodiment of the invention, accelerator 911 is part of the NIC. In an embodiment, the NIC is on the same chip as general purpose instruction-based processor 920. In an alternative embodiment, the NIC 910 is on a separate chip coupled to general purpose instruction-based processor 920. In an embodiment, the NIC-based accelerator receives an incoming packet, as input data elements through I/O interface 912, processes the packet and generates the response packet(s) without involving general purpose instruction-based processor 920. Only when accelerator 911 cannot handle the input packet by itself, the packet is transferred to general purpose instruction-based processor 920. In an embodiment, accelerator 911 communicates with other I/O interfaces, for example, storage elements through direct memory access (DMA) to retrieve data without involving general purpose instruction-based processor 920.

Accelerator 911 and the general purpose instruction-based processor 920 are coupled to shared memory 943 through private cache memories 941 and 942 respectively. In an embodiment, shared memory 943 is a coherent memory system. The coherent memory system may be implemented as shared cache. In an embodiment, the coherent memory system is implemented using multiples caches with coherency protocol in front of a higher capacity memory such as a DRAM.

In an embodiment, the transfer of data between different layers of accelerations may be done through dedicated channels directly between accelerator 911 and processor 920. In an embodiment, when the execution exits the last acceleration layer by accelerator 911, the control will be transferred to the general-purpose core 920.

Processing data by forming two paths of computations on accelerators and general purpose instruction-based processors (or multiple paths of computation when there are multiple acceleration layers) have many other applications apart from low-level network applications. For example, most emerging big-data applications in data centers have been moving toward scale-out architectures, a technology for scaling the processing power, memory capacity and bandwidth, as well as persistent storage capacity and bandwidth. These scale-out architectures are highly network-intensive. Therefore, they can benefit from acceleration. These applications, however, have a dynamic nature requiring frequent changes and modifications. Therefore, it is highly beneficial to automate the process of splitting an application into a fast-path that can be executed by an accelerator with subgraph templates and a slow-path that can be executed by a general purpose instruction-based processor as disclosed herein.

While embodiments of the invention are shown as two accelerated and general-purpose layers throughout this document, it is appreciated by one skilled in the art that the invention can be implemented to include multiple layers of computation with different levels of acceleration and generality. For example, a FPGA accelerator can backed by a many-core hardware. In an embodiment, the many-core hardware can be backed by a general purpose instruction-based processor.

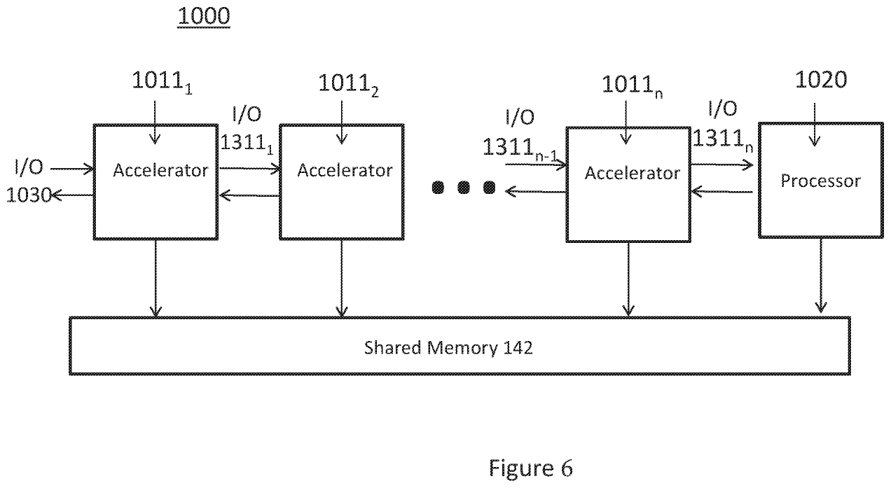

Referring to FIG. 6, in an embodiment of invention, a multi-layer system 1000 that utilizes subgraph templates is formed by a first accelerator 1011₁ (e.g., in-line accelerator, offload accelerator for offloading processing from another computing resource, or both) and several other accelerators 1011ₙ (e.g., in-line accelerator, offload accelerator for offloading processing from another computing resource, or both). The multi-layer system 1000 includes several accelerators, each performing a particular level of acceleration. In such a system, execution may begin at a first layer by the first accelerator 1011₁. Then, each subsequent layer of acceleration is invoked when the execution exits the layer before it. For example, if the accelerator 1011₁ cannot finish the processing of the input data, the input data and the execution will be transferred to the next acceleration layer, accelerator 1011₂. In an embodiment, the transfer of data between different layers of accelerations may be done through dedicated channels between layers (e.g., 1311₁ to 1311ₙ ). In an embodiment, when the execution exits the last acceleration layer by accelerator 1011ₙ, the control will be transferred to the general-purpose core 1020.

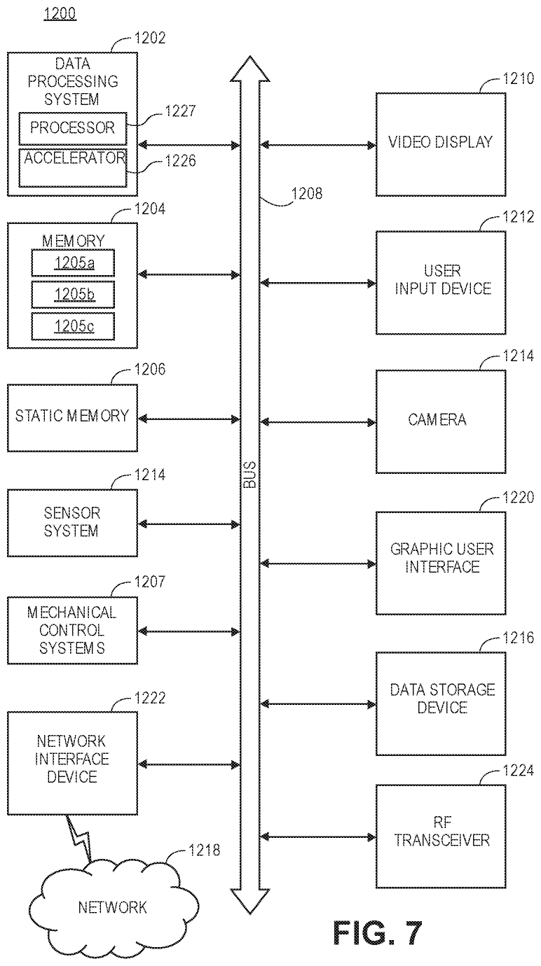

FIG. 7 is a diagram of a computer system including a data processing system that utilizes subgraph templates according to an embodiment of the invention. Within the computer system 1200 is a set of instructions for causing the machine to perform any one or more of the methodologies discussed herein. In alternative embodiments, the machine may be connected (e.g., networked) to other machines in a LAN, an intranet, an extranet, or the Internet via network 1218. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes a general purpose instruction-based processor 1227 and an accelerator 1226 (e.g., in-line accelerator, offload accelerator for offloading processing from another computing resource, or both). The general purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein.

The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1200. In one embodiment, the software components include operating system 1205a, compiler component 1205b for executing a matching algorithm and selecting templates that at least partially match input subgraphs, and communication module (or set of instructions) 1205c. Furthermore, memory 1206 may store additional modules and data structures not described above.

Operating system 1205a includes various procedures, sets of instructions, software components and/or drivers for controlling and managing general system tasks and facilitates communication between various hardware and software components. A compiler is a computer program (or set of programs) that transform source code written in a programming language into another computer language (e.g., target language, object code). A communication module 1205c provides communication with other devices utilizing the network interface device 1222 or RF transceiver 1224.

The computer system 1200 may further include a network interface device 1222. In an alternative embodiment, the data processing system disclose is integrated into the network interface device 1222 as disclosed herein. The computer system 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), a camera 1214, and a Graphical User Interface (GUI) device 1220 (e.g., a touch-screen with input & output functionality).

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The Data Storage Device 1216 may include a machine-readable storage medium (or more specifically a computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202 by the computer system 1200, the main memory 1204 and the data processing system 1202 also constituting machine-readable storage media.

In one example, the computer system 1200 is an autonomous vehicle that may be connected (e.g., networked) to other machines or other autonomous vehicles in a LAN, WAN, or any network. The autonomous vehicle can be a distributed system that includes many computers networked within the vehicle. The autonomous vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The autonomous vehicle can operate in the capacity of a server or a client in a client-server network environment, or as a peer machine in a peer-to-peer (or distributed) network environment. The storage units disclosed in computer system 1200 may be configured to implement data storing mechanisms for performing the operations of autonomous vehicles.

The computer system 1200 also includes sensor system 1214 and mechanical control systems 1207 (e.g., motors, driving wheel control, brake control, throttle control, etc.). The processing system 1202 executes software instructions to perform different features and functionality (e.g., driving decisions) and provide a graphical user interface 1220 for an occupant of the vehicle. The processing system 1202 performs the different features and functionality for autonomous operation of the vehicle based at least partially on receiving input from the sensor system 1214 that includes laser sensors, cameras, radar, GPS, and additional sensors. The processing system 1202 may be an electronic control unit for the vehicle.

This present design discusses the advantages and benefits of computation near storage or computational storage in the context of Big Data analytics. A solid state drive (SSD) or solid state device is a computational storage platform that provides an opportunity for ultra-fast data transfers from storage to FPGAs, which is a perfect fit for big data processing. A solid-state drive is a solid-state storage device that uses integrated circuit assemblies to store data persistently, typically using flash memory, and functioning as secondary storage in the hierarchy of computer storage.

In this present application, a full stack acceleration approach is discussed for modern open source Big Data environments on accelerators like FPGAs and GPUs, with focus on Apache Spark as a Big Data environment and FPGAs as acceleration devices. This present design discusses changes that were made to a traditional software and hardware stack in order to incorporate computational storage platforms. The present design describes cross-stack optimizations necessary to achieve high throughput and low latency for SQL query processing for SSDs. Finally, this present design showcases results on TPC-DS benchmarks, which are state-of-the-art SQL benchmarks designed for Big Data analytic platforms. The results show up to 6× end to end query runtime speedup for scan-heavy TPC-DS queries, compared to query runtime for the same queries executed by vanilla Spark and an average of 4× across all TPC-DS queries.

As Moore's law is slowing down, traditional CPU and transistor scaling no longer translates to performance scaling for data centers and cloud systems. As a solution to this problem, the industry has come up with a number of hardware accelerators to speedup processing at different domains such as machine learning, data analytics and graph processing. A clear indicator of this trend is the fact that accelerators such as FPGAs, GPUs and tensor processing units (TPUs) are now available in cloud and data centers.

Unfortunately, a semantic gap exists between the low-level programming model of the accelerators and the high-level analytics languages used by data scientists and data engineers. Data scientists and engineers are not able to easily program and use these accelerators as they need to program using hardware description languages or low-level programming languages such as CUDA/OpenCL. Even if the vendors provide high level software libraries and APIs, the cost of changing analytics code is significant. The present design develops hardware-software co-developed solutions for enterprise and cloud-based data centers to fill this gap. Our software platform enables accelerated computing for Big Data analytics using accelerators without requiring any code change. This is especially important for cleansing, managing, and analyzing huge volumes of data that's emerging from AI/ML solutions.

Today's clusters are typically managed using open source software applications (e.g., Spark, Hive, etc. . . ) on x86-based hardware servers. The present design focuses on a computational storage platform to be used as a hardware accelerator near storage. Through our technology, this present design exploits special operational mode in SSD which performs a large part of processing in the analytic workloads on the in-storage peer device and significantly improves performance and throughput.

The present application discusses prior approaches, SSD components and operational mechanisms, software stack technology and how it enables acceleration without any code change for analytic applications, hardware architecture and hardware/software interface, respectively, and then design and results on row-based data format for TPC-DS benchmarks respectively.

Computation near storage or computational storage is an emerging technology that is proving to be essential in modern data-center infrastructures so much so that the Storage Networking Industry Association (SNIA) has created a Computational Storage Technical Work Group to focus on standardizing this technology. The idea of query processing on SSD has been explored in works like where Microsoft SQL Server was used to run queries on older research-level SSD. However, such frameworks are not suited for Big Data workloads. This present design uses FPGA without user code change and thus achieves higher performance Additionally, this design is targeted towards Big Data environments, where data size ranges from petabytes to terabytes being processed in clusters. Finally, this design provides an industrial level SSD. Prior approaches discuss SSD targeting applications like log analysis and document search while this present design includes SQL Big Data analytics. Also, these prior works were based on SATA or SAS attached SSD while this design works with a PCIe attached card which provides higher SSD throughput. On the software side, this design uses OpenCL API to access SSD from host application when compared to the GET-PUT style requests and this leads to a better event model for our applications

With the ever-growing amount of data that needs to be processed by data-centers, it is critical that servers be able to consume data effectively from storage devices. The present design defines computational storage as the ability to do computation or data processing at the storage device level or near storage, before data is moved to host memory. This design will exclusively talk about computational storage with respect to a smart SSD platform. The advantages of having computational storage have been discussed in many prior works, the primary ones being reducing the computational complexity and volume of data reaching CPU's host memory and scaling processing capability to maximize storage bandwidth.

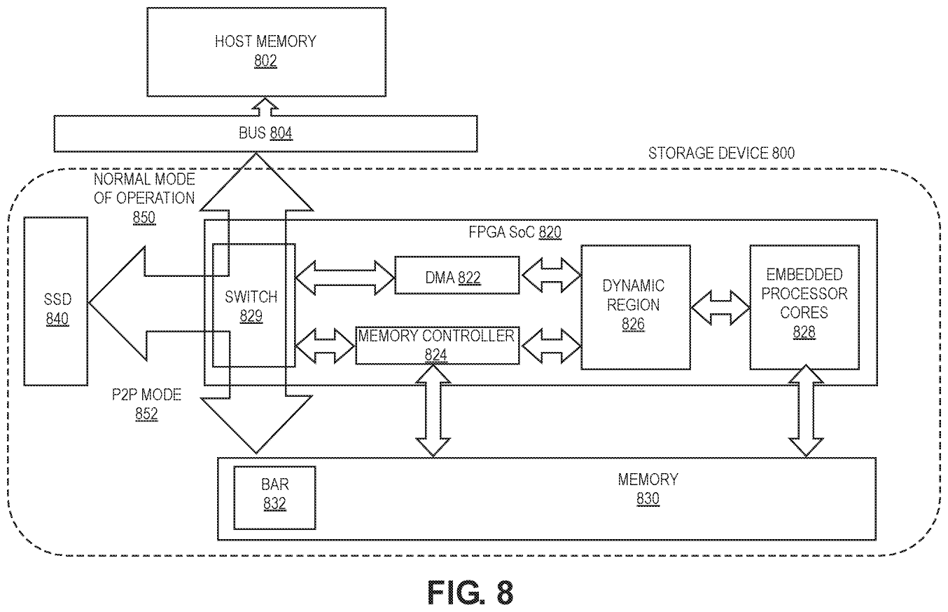

The components of a smart storage platform are shown in FIG. 8 in accordance with one embodiment. The storage device 800 (e.g., smart SSD platform 800, computational storage device) contains a FPGA 820 and memory 830 (e.g., NAND Flash Arrays with 1 TB capacity) on the same board which has a form factor of a PCIe add-in card. In one example, the FPGA 820 used is a SoC and has 4 cores. The FPGA 820 includes a switch 829, a direct memory access (DMA) controller 822, a memory controller 824, a dynamic region 826, and embedded processor cores 828. The dynamic region is reconfigurable and programmed at run-time based on an analytic query being processed. In one example, the dynamic region is configured from one SQL stage (e.g., sub-query to another sub-query). Operators specific to a smart storage platform could also be configured in the dynamic region. The PCIe in this card has a theoretical max throughput of 4 GB/s. In one example, the board contains 8 GB DDR operating at 2400 Mhz which acts as an intermediate buffer when data is transferred from SSD 830 to FPGA 820 and from FPGA to host memory 802 via bus 804. There is a three-way PCIe switch 829 present in the FPGA 820 which in one example has an aggregate 24 GB/s bandwidth(BW) with 4 GB/s to/from SSD 840, 4 GB/s from/to FPGA 820 and 4 GB/s from/to host 802. Smart SSD supports two modes of data transfer: normal mode 850 and Peer-to-Peer (P2P) mode 852. Under the normal mode, read/write is issued by the host and data is transferred between SSD 830 and host memory 802 through switch 829.

It is important to note that under normal reads, data is also transferred through the PCIe switch 829 in the FPGA 820 onto the PCIe Bus 804. The second mode of operation is the Peer-to-peer (P2P) mode 852, in which data is transferred from the SSD 840 to memory 830 for processing by the local peered devices. For the P2P mode, there is a reserved 4 GB location in the memory 830 termed Common Memory Area (CMA) which is accessible by the SSD, the FPGA and the host. This CMA is memory mapped to the host as a FPGA PCIe BAR address of the PCIE bar 832. From the software perspective, all access to accelerators and computing on P2P data in the smart SSD goes through OpenCL framework. An application that would like to use the P2P mode from host software needs to allocate memory in the CMA using OpenCL libraries and extensions provided by clCreateBuffer with P2P flag in this case. The allocated memory can then be mapped, using clEnqueueMapBuffer OpenCL call, to the host address space. The resulting virtual address can then be used by the SSD for direct read/write access into FPGA CMA. This constitutes P2P mode of operation for the SSD.

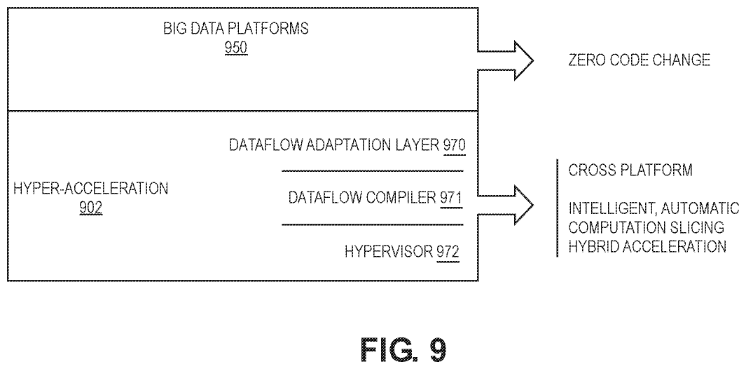

FIG. 9 illustrates software layers which facilitate using accelerators in Big Data applications seamlessly. A technology hyper-acceleration stack 902 includes three important layers as illustrated in FIG. 9: data-flow adaptation layer 970, data-flow compiler 971, and hypervisor 972. The data-flow adaptation layer 970 converts internal data-flow of Big Data frameworks 950 (e.g., Apache Spark, Hive, Presto or Tensorflow) into a canonical data-flow format of the present design. In one example, the present design utilizes Apache Spark which is one of several Big Data application frameworks popular for its higher performance due to in-memory processing. This design has a canonical data-flow format that includes several computation and communication-related operators that cover analytics and machine learning operations. The implementation of these operators are not tied to any platform.

A data-flow compiler layer 971 is responsible for compiling the canonical data-flow, which is generated for each application and mapping to pre-compiled accelerator templates which slice the computation between different heterogeneous devices. The features of this layer include being a cross-platform for different heterogeneous devices, intelligent automatic computation slicing, and hybrid acceleration.

In one example, hypervisor 972 is a high performance C++ library that interacts with heterogeneous devices like FPGA, GPU, multi-core CPU and smart SSD, some of which may exist on each worker node in the cluster. The pre-compiled accelerator templates generated by the data-flow compiler layer, along with application binary, are broadcast to all worker nodes of the cluster. A modified Spark executor, at run time, executes the accelerated version of the task. The accelerated task interacts with the hypervisor to execute the pre-compiled templates on the accelerator (e.g., GPU, FPGA, multi-core CPU, smart SSD). The hypervisor layer chooses templates that can run on FPGA, GPU or CPU based on cost-functions for operators of that stage.

To better describe the integration with Spark, the present application discusses how Spark executes user applications on clusters. The present application then explains how the Spark execution obtains seamless acceleration during run-time on different types of accelerator devices across the three layers described herein.

In Apache Spark, a user application is executed by a driver program and one or more executors. The driver program takes user code and dispatches it to executors in multiple worker nodes. First, the driver breaks down the user code into a directed acyclic graph (DAG) of stages. In this DAG, the operators that have linear dependency (such as file scan, filter, or map) are grouped in one stage. However, if the operators have more complex dependencies (such as groupBy or join), then the operators will end up in different stages. When running a SQL code, Spark SQL compiler or Catalyst converts the code into an optimized query plan. A query plan describes SQL operators and their dependences in the query. Eventually, Catalyst generates an execution DAG which is executed across the cluster in the form of stages and tasks, as explained. Please note that the acceleration stack hypervisor of the present design is different from a hypervisor used in virtual machines. This computational stack of the present design can work across all containers and hypervisor environments.

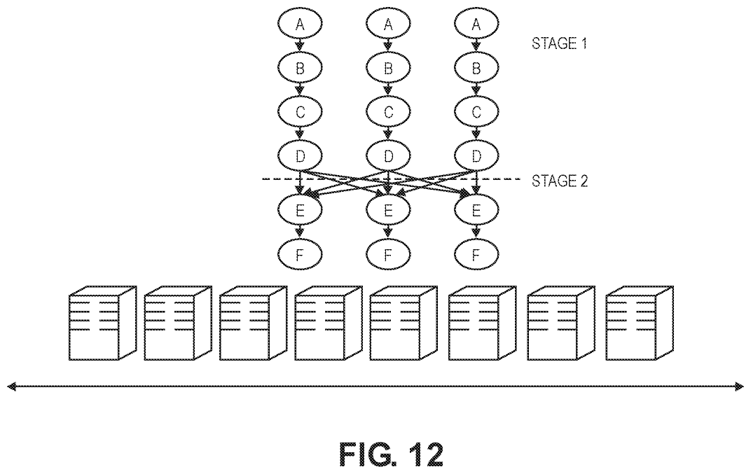

Spark divides the data for each stage into multiple data partitions across the cluster. When running a stage, Spark executors run the operators in that stage as a set of tasks. Each task is associated with an independent data partition so tasks can run in parallel. As an example, FIG. 12 shows an application with two stages. The first stage has four operators (A, B, C, and D). At runtime, the stages are executed in the order of DAG dependencies. In this case, Stage 1 gets executed before Stage 2 and each stage runs three tasks on different partitions of data. For large number of data partitions, a stage might consist of thousands of tasks. When all tasks in stage 1 finish, the results are re-distributed across executors (also known as shuffling). This redistribution acts as a synchronization barrier for all executors and upon completion of shuffling, executors move to Stage 2 of the DAG.

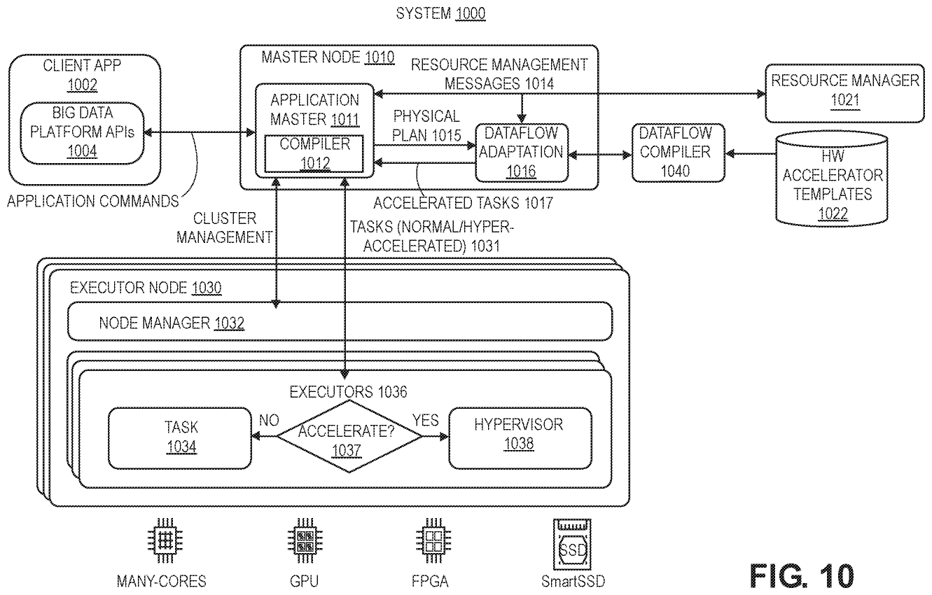

FIG. 10 shows a system 1000 having hyper-acceleration layers to accelerate queries (e.g., Spark queries) in accordance with one embodiment. The system 1000 includes a client application 1002 having Big Data platform APIs 1004, a master node 1010, a resource manager 1021, hardware accelerator template database 1022, and an executor node 1030 having a node manager 1032. The resource manager 1021 can send resource management messages 1014 to application master 1011. The hyper-acceleration layers include dataflow adaption 1016, dataflow compiler 1040, and hypervisor 1038. A physical plan arrow 1015 signifies input received by the data-flow adaptation layer 1016. As illustrated in this FIG. 10, a user application 1002 sends application commands to the master node 1010 to cause software code to be compiled in a Spark driver (e.g., application master 1011) by a Spark query compiler 1012.

A hardware accelerator template database 1022 includes several templates which are associated with a linear set of operators referred to as Linear Stage Trace (LST). In other words, LST can be considered as a subset of operators that need to be executed sequentially within a stage. In one example, a LST includes scan, filter, project, and partial hash aggregate operators. In case of FPGAs, a template includes a partially re-configurable bit file, which is pre-synthesized and optimized to accelerate each operator in the LST. In case of GPUs, a template includes CUDA/OpenCL binary that implements the operators in the LST. In case of CPUs, the templates include native (C++) code which links to optimized libraries of the present design. There is a cost function that determines which LSTs need to be implemented on accelerators. This cost function is by offline profiling of different operators in production ETL pipelines and SQL pipelines and it is tuned to be more effective by adding new profiling data over time.

Adaptation layer 1016 interacts with Spark query compiler 1012 and converts the output of Spark query compiler, known as physical plan 1015 to a canonical data-flow intermediate representation. This canonical representation is output given to data-flow compiler 1040, and based on accelerator template availability, data-flow compiler 1040 generates accelerator code for accelerated tasks 1017 which can be communicated with available accelerators (e.g., FPGA, GPU, Smart SSD, Many-cores) and will be running on each executor 1036. If data-flow compiler decides not to accelerate a stage, that stage will be executed through the original Spark execution path. The tasks 1031 received by the executors 1036 can be normal tasks 1034 or hyper-accelerated tasks handled by hypervisor 1038 based on whether acceleration operation 1037 is applied or not.

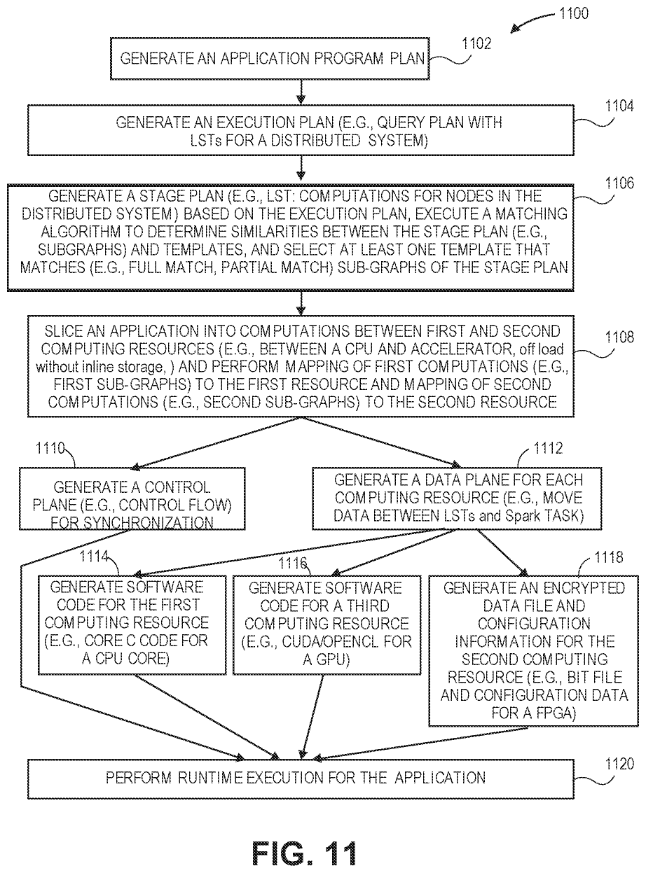

FIG. 11 is a flow diagram illustrating a method 1100 for accelerating big data operations according to an embodiment of the disclosure. Although the operations in the method 1100 are shown in a particular order, the order of the actions can be modified. Thus, the illustrated embodiments can be performed in a different order, and some operations may be performed in parallel. Some of the operations listed in FIG. 11 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of method 1100 may be executed by a compiler component, a data processing system, a machine, a server, a web appliance, a centralized system, a distributed node, or any system, which includes an in-line accelerator. The in-line accelerator may include hardware (circuitry, dedicated logic, etc.), software (such as is run on a general purpose computer system or a dedicated machine or a device), or a combination of both. In one embodiment, a compiler component performs the operations of method 1100.

At operation 1102, the method includes generating an application program plan. At operation 1104, the method includes generating an execution plan (e.g., query plan with LSTs for a distributed system). In one example, a distributed system (e.g., Spark) performs operations 1102 and 1104. At operation 1106, the method generates a stage plan (e.g., computations for nodes in the distributed system) for the application program based on the execution plan, executes a matching algorithm to determine similarities between the stage plan (e.g., subgraphs) and unique templates from an available library of templates, and selects at least one template that matches (e.g., full match, partial match) sub-graphs of the stage plan. At operation 1108, the method slices an application into computations between first and second computing resources (e.g., between a first execution unit and a second execution unit, between a CPU and in-line accelerator) and performs mapping of first computations (e.g., first subgraphs) to the first resource and mapping of second computations (e.g., second subgraphs) to the second resource. In one example of operation 1108, a compiler generates a linear stage trace (LST) with a LST being a linear subgraph of the DAG or data-flow graph. The present design is not restricted to linear graphs and can operate on any kind of Directed Acyclic Graph (DAG). The compiler matches the stage plan to unique templates from an available library of templates, then generates FPGA, GPU and/or CPU specific control and data information for runtime execution flow by utilizing selected templates.

At operation 1108, in one example, slicing and mapping occurs based on LSTs in each stage of the query plan and matching accelerator templates in the template database. The compiler maps each part of the query plan to different computational resources (e.g., FPGA, GPU, CPU, etc.). The cost function for each operator helps choose the best accelerator match for each LST in each query plan.

At operation 1110, the method generates a control plan for synchronization. The Control plane includes software code that is generated for transitioning the control flow between LSTs and the Spark task.

At operation 1112, the method generates a data plane for each computing resource (e.g., each CPU core, each accelerator). The data plane includes software code to move the data between LSTs and the spark task.

At operation 1114, the method generates software code for the first computing resource (e.g., core C code for a CPU core). At operation 1116, the method generates software code for a third computing resource (e.g., CUDA/OpenCL for a GPU). At operation 1118, the method generates an encrypted data file and configuration information for the second computing resource (e.g., BIT file and configuration data for a FPGA). At operation 1120, the method performs runtime execution for the application (e.g., big data application). In one example, a data flow compiler may perform operations 1106-1118.

As a result of a data-flow compiler, an accelerator code is generated and it is ready to be executed by a hypervisor layer. At a high-level, a hypervisor layer is responsible for picking LSTs in a stage, loading the right accelerator code for it (if exists), preparing the environment for task execution if necessary (e.g., FPGA partial programming), and executing the code on the accelerator device.

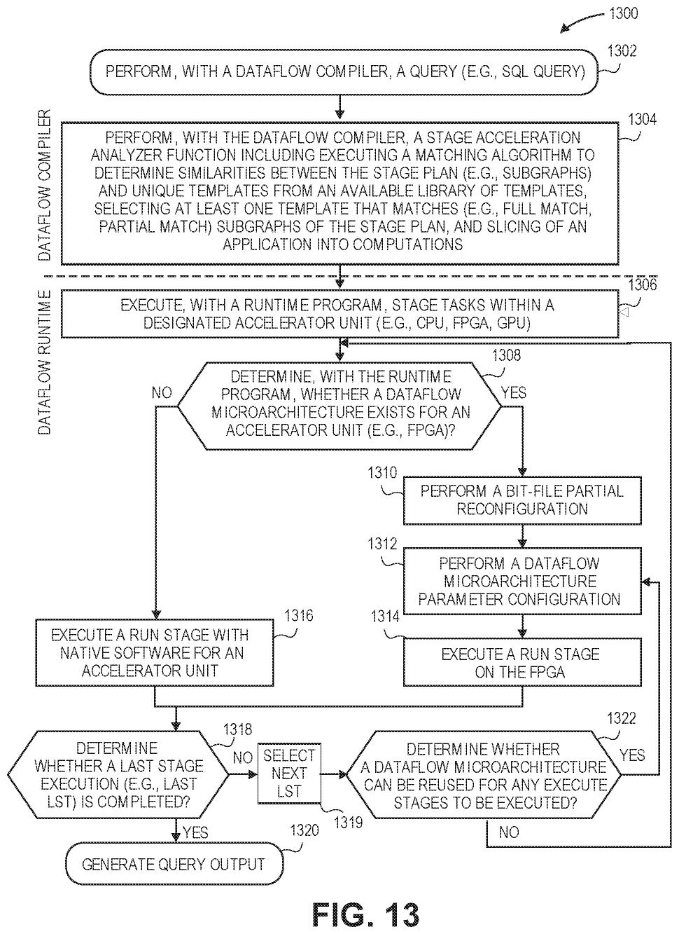

Now the present application will describe run-time components in a hypervisor layer for an example shown in FIG. 12. FIG. 13 illustrates the acceleration of the first stage of this sample query. As shown in FIG. 12, the first stage includes operators A, B, C and D. There can be multiple LSTs associated with this stage since there are multiple ways to group operators in a sequential way. The design shows an LST with operators X, Y, and Z, which X should be executed before Y and Y should be executed before Z, as LST{X,Y,Z}. In this example, stage 1 can be represented by (LST{A,B}, LST{C,D}), or (LST{A}, LST{B,C,D}), or (LST{A}, LST{B}, LST{C}, LST{D}), etc.

FIG. 13 is a flow diagram illustrating a method 1300 for runtime flow of big data operations by utilizing subgraph templates according to an embodiment of the disclosure. Although the operations in the method 1300 are shown in a particular order, the order of the actions can be modified. Thus, the illustrated embodiments can be performed in a different order, and some operations may be performed in parallel. Some of the operations listed in FIG. 13 are optional in accordance with certain embodiments. The numbering of the operations presented is for the sake of clarity and is not intended to prescribe an order of operations in which the various operations must occur. Additionally, operations from the various flows may be utilized in a variety of combinations.

Upon receiving FPGA, GPU or CPU specific control and data information from a data flow compiler of the present design, a runtime program executes the stage tasks inside the designated accelerator unit (e.g., CPU, FPGA, GPU) until the last stage is completed. The initial execution of an FPGA accelerated function within a stage requires bit-file partial reconfiguration (e.g., operation 1310). This typically takes milliseconds. After the initial bit-file is downloaded, all subsequent application specific selectable parameters (e.g., filter values) are configured (e.g., operation 1312) without requiring a bit-file partial reconfiguration. Parameter configurations or software personalities enable reuse across multiple applications. Data flow execution runs in a loop according to the control information until the last stage execution is completed.

At operation 1302, a dataflow compiler performs a query (e.g., SQL query). At operation 1304, dataflow compiler performs a stage acceleration analyzer function including executing a matching algorithm to determine similarities between the stage plan (e.g., sub-graphs) and unique templates from an available library of templates, selecting at least one template that matches (e.g., full match, partial match) sub-graphs of the stage plan, and slicing of an application into computations. At operation 1306, a runtime program executes stage tasks within a designated accelerator unit (e.g., CPU, FPGA, GPU). At operation 1308, the runtime program determines whether a dataflow microarchitecture exists for an accelerator unit (e.g., FPGA).

If so, then the runtime program performs a bit-file partial reconfiguration at operation 1310. At operation 1312, the runtime program performs a dataflow microarchitecture parameter configuration. At operation 1314, the runtime program executes a run stage on the FPGA.

If no dataflow microarchitecture exists, then the runtime program executes a run stage with native software for an accelerator unit at operation 1316. At operation 1318, the runtime program determines whether a last stage execution is completed. If so, then the method proceeds to generate query output at operation 1320. If not, then the method proceeds to select the next execution stage (e.g., next LST) at operation 1319 and determine whether a dataflow microarchitecture can be reused at operation 1322 for any execute stages to be executed. If so, then the method proceeds to operation 1312. If not, then the method returns to operation 1308.

In one example of method 1300, a data-flow compiler determines FPGA accelerators for LST{A}, LST{C} and LST{D}. The data-flow compiler also determines a native accelerator for LST{B}. This means that operators A, C, and D will be executed on a FPGA, while operator C will be executed on a CPU by native code for the operators of FIG. 12. A list and order of LSTs that are going to be executed at each time is determined by an execution plan. In one example, the method selects LST{A} first. Since this LST can be executed on FPGA, the hypervisor programs the bit file from the template at operation 1310 and it configures the FPGA with specific parameters from the template at operation 1312. Then, the method executes LST{A} on the FPGA at operation 1314. According to a data-flow compiler, the next LST would be LST{B}. Since this LST has a native template, this LST will be executed on CPU with native libraries at operation 1316.

LST{C} is the next LST to be picked at operation 1319. According to template information, the template for current programmed template (in this case, template for LST{A}) cannot be reused for LST{C} as determined at operation 1322. Therefore the process for re-programming the bit file and parameter configuration need to be done for this LST (e.g., operations 1310, 1312, 1314). The next LST is LST{D}. The template information for current programmed template (i.e., LST{C}) and LST{D} shows that the bit file for LST{C} can be re-used for LST{D} as determined at operation 1322. Therefore, this method with hypervisor skips bit file programming operation 1310 and only performs parameter configuration at operation 1312 and runs LST{D} on FPGA at operation 1314. Since LSD{D} is the last one as determined at operation 1318, the result will be considered as stage 1 results at operation 1320. The same flow will be repeated for stage 2 of FIG. 12. In one example, all of the above hypervisor operations are executed as a Spark task running on a Spark executor.

This next section focuses on the flow of accelerated query execution in Spark. In the next section, this present design focuses more on the architecture of the FPGA accelerators.

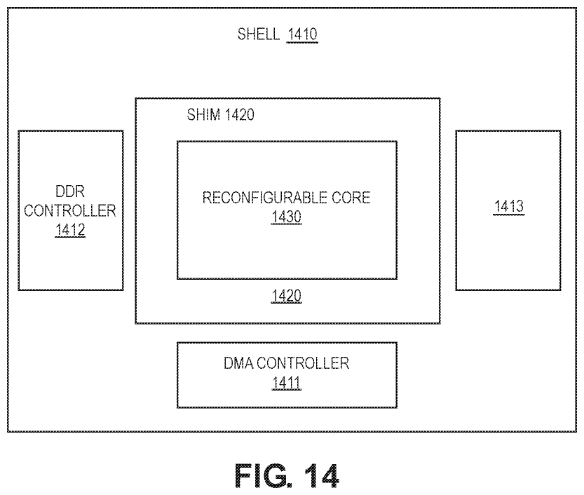

As shown in FIG. 14, logically the design components of FPGA can be split into three sections: shell 1410, shim 1420 and core 1430 in accordance with one embodiment. The shell region has fixed IP components that interact outside of FPGA, such as PCIe controller 1413, DMA controller 1411, DDR controller 1412, Ethernet controller etc. The shell region is typically provided by a FPGA vendor. The next layer in question is a proprietary shim layer 1420, which converts external bus interfaces to compatible interfaces for a core of the present design. An example of this is converting from memory mapped interface to streaming interface which is the most common interface in the templates. The shim layer also collects error and performance metrics from the core.

The partially re-configurable component of the design is the core region 1430. The core corresponds to SQL, machine learning and deep-learning operators or subset of operators that can be mapped and accelerated in FPGA. The core region, which include RTL IPs, is converted to RTL Kernels in a development environment. This enables using the same software interface model as OpenCL instantiated kernels. Based on the area constraints of the FPGA, the core region can include multiple RTL kernels. The independent RTL kernels operate on mutually exclusive partitions of data. These RTL Kernels can be considered as logically equivalent of having multiple independent cores in a processor.

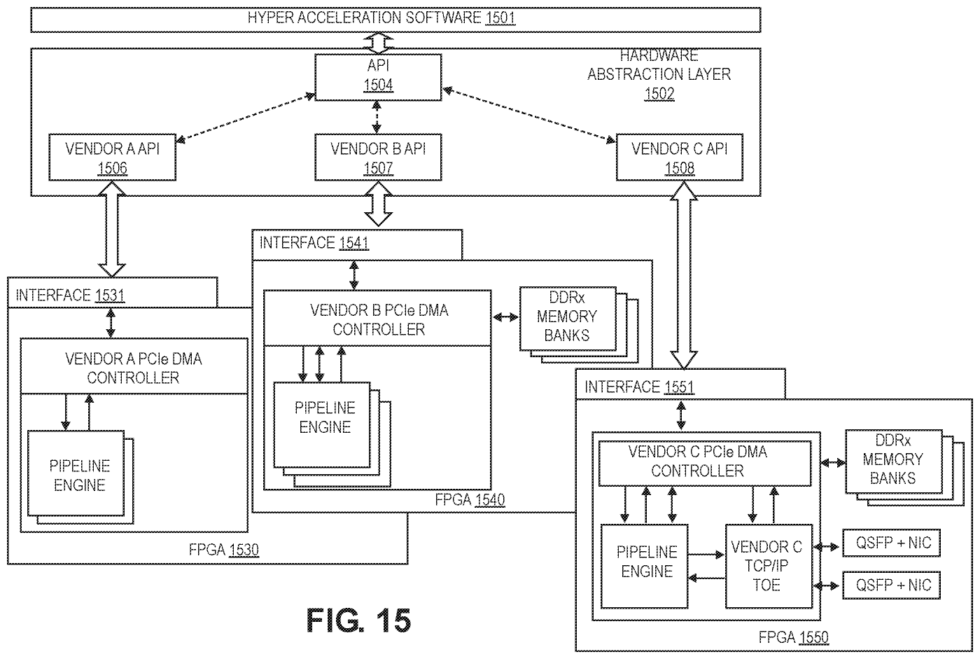

As discussed above, a data-flow compiler is responsible for generating codes for specific accelerators like FPGAs and hypervisor is responsible for executing the generated codes on the accelerators. The hypervisor layer communicates to low level device-specific drivers through an interface class which has a fixed set of APIs (e.g., APIs 1504, 1506, 1507, 1508) that are called at runtime by any operator that wishes to use FPGA. The translation of these API calls to device-specific drivers are handled through a Hardware Abstraction Layer 1502. As shown in an interface between software and hardware in FIG. 15, these API calls that abstract away device-specific drivers are being standardized through an open-API initiative, or OHAI (Open Hyper Acceleration Initiative). These API calls belong to an interface class called OHAI class interface. Each Spark executor can potentially have an operator in every stage that instantiates the OHAI class interface to accelerate on FPGA. All such interfaces contend to access resources (e.g., DMA controller, Pipeline engine, DDR memory banks, TCP/IP and TCP offload engine (TOE), network interface module such as quad small form-factor pluggable (QSFP), 40 G network interface card) of FPGAs 1530, 1540, and 1550 via respective interfaces 1531, 1541, and 1551 (e.g., Gen3X8, x16 PCIExpress). The present design has implemented a priority round-robin scheduling to grant access to FPGA resources. The software and hardware interfaces were originally targeted for offload mode of processing, in which data is brought to host memory and then send to FPGA for compute acceleration. In this mode, FPGA can be logically considered to be a co-processor to CPU cores, sharing host memory with them.

Templates can be adapted for smart SSD and associated optimization necessary for high performance. With reference to the hardware logical layers in FIG. 15, the shell layer for a smart SSD is provided. A shim layer, designed for offload mode, can have minor modification on the DDR interfaces to adapt to P2P shell. Kernels of the present design consume Spark data partitions from FPGA CMA and send the processed data back to host memory in a format similar to Tungsten rows, which is an in-memory format used in Spark. For interoperability, all of row based hardware templates process data internally in a format that is similar to Tungsten. The present design ports multiples of these row based templates to smart SSD so that based on the query being processed the design can reconfigure the core region. All templates in the core receive data to process from FPGA CMA and send the result back to FPGA DDR. Since the LUT count (522K) of the FPGA in smart SSD is smaller than that of FPGA targeted for offload acceleration), this design ports only a smaller number of kernels to the smart SSD. After porting our design, the configurable logic blocks (CLB) utilization was 52% to 64% for the present design with the core region operating at 200 Mhz for the row-based templates with three kernels. On the software side, changes occur such that data partitions generated by Spark are read into P2P CMA as opposed to host memory in the offload implementation. This required adding a Spark partition file receiver specifically targeted for P2P transfer. In the case of accelerating operations that read data from disk, the start of a scan operator issues a P2P read to transfer the data from SSD to FPGA CMA and once the data transfer is complete this design enqueues an OpenCL compute task to operate on the data in CMA.

An important optimization that is necessary for good performance is to decouple the P2P command queue from compute command queue. This is necessary because the design can have data transfers initiated to the FPGA CMA region through P2P command queue, while the compute command queue is being processed on another CMA region. A further optimization is to use asynchronous read for P2P as opposed to synchronous read so that a single thread can operate on both P2P and compute command queue. Since drivers support POSIX API for P2P read, this design used aio read as opposed to pread or read. This also enables all OpenCL calls as non-blocking and asynchronous, so as to issue multiple commands to both command queues on a single thread effectively. This also reduces CPU utilization by avoiding polling/busy-waiting. Another optimization tool is to use the Embedded Run Time (ERT) option which reduces polling on the CPU side by moving the polling to a processor in the FPGA. The results will be discussed with respect to JSON data format which is one of the predominant row based formats used in big data analytics.

Another important advantage of Smart SSD is lower CPU utilization. The peak CPU utilization of the present design is less than 30% while that of Spark is around 90% for the cores executing the query. Across all TPC-DS scan heavy queries, CPU utilization was similarly low for Smart SSD. In production environments, with multi-tenancy support, lower CPU utilization could lead to more workloads being run on the same machine through different containers.

For a Single Tenant, a single instance of the software and supporting infrastructure serve a single customer. With single tenancy, each customer has his or her own independent database and instance of the software.

For Multi-Tenant, a single instance of the software and its supporting infrastructure serves multiple customers. Each customer shares the software application and also shares a single database. Each tenant's data is isolated and remains invisible to other tenants.

A testbed for this example includes 5 servers with 1 driver node and 4 worker nodes with smart SSD attached to the PCIe Slot. Each server contains a CPU operating at 2.10 GHz with 22 physical cores in dual sockets. Each server contains 128 GB DRAM and the servers are connected through a 10 Gbps network.

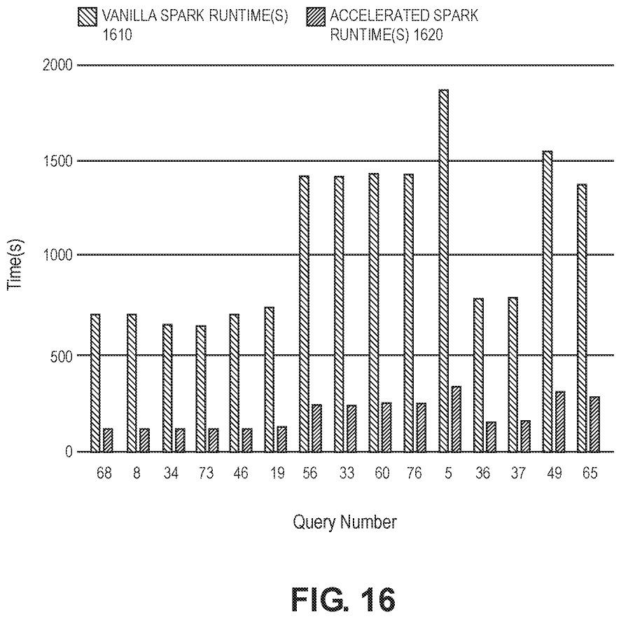

FIG. 16 compares performance of scan heavy TPC-DS queries between vanilla Spark 1610 and accelerated Spark 1620 of the present design in smart SSD for a single node. These measurements were made after all the aforementioned hardware optimizations and the results presented are end-to-end query time for 200 SF (200 GB) data. As is observable from FIG. 16, most queries achieve around 6× acceleration with respect to Spark. The number of Spark executors was set to 6 with a total executor memory of 100 GB. The executor count being 6 for one SSD is a comparable equivalent to one FPGA. The top-10 queries are presented for both cases separately since these are not the same subset for both of them and the baseline Spark performance also varies between smart SSD and SATA connected SSD.

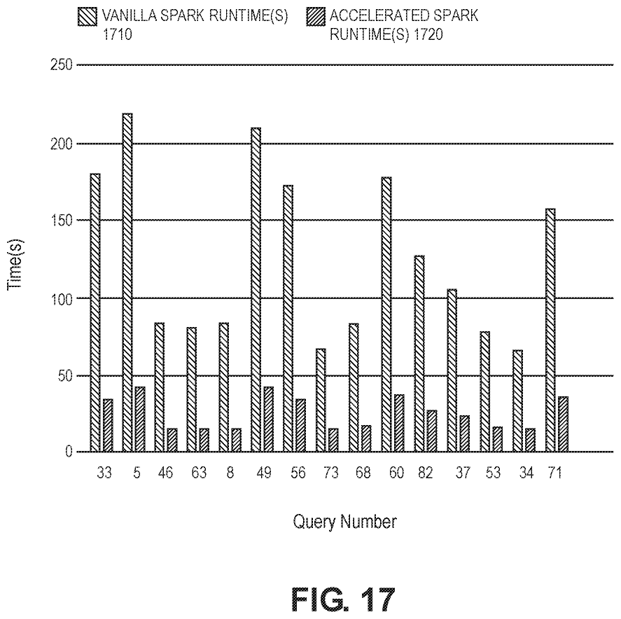

FIG. 17 shows results for a 4 node cluster for vanilla Spark 1710 and accelerated Spark 1720 of the present design with each node having 100 GB of TPC-DS data totaling 400 GB for the cluster. The acceleration numbers here of around 6× acceleration are similar to that of single node cluster. In cluster configuration, data is distributed across a smart SSD of each node and scan operation and operators succeeding scan are processed in smart SSD. Once scan stage is complete, shuffle data is also placed in smart SSD so that it can be redistributed to other nodes.

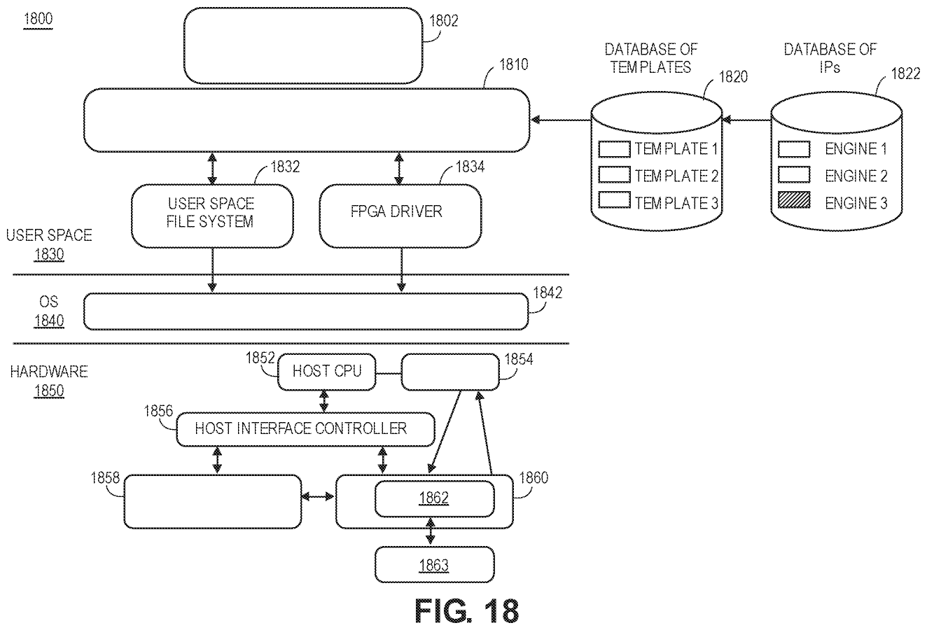

FIG. 18 shows an embodiment of a block diagram of an accelerator architecture for accelerating big data operations by utilizing subgraph templates in accordance with one embodiment. An accelerator architecture 1800 (e.g., data processing system) includes an analytics engine 1802 for large scale data processing, an acceleration functionality 1810, a database of templates 1820, and a database of intellectual property (IP) engines 1822. A user space 1830 may include an optional user space driver 1832 (e.g., user space network adapter, user space file system) and a software driver 1834 (e.g., FPGA driver). An operating system (OS) 1840 includes a software driver 1842 (e.g., NVMe/PCIe driver). Hardware 1850 of the accelerator architecture includes a Host CPU 1852, memory 1854 (e.g., host DRAM), a host interface controller 1856, a solid-state storage device 1858, and an accelerator 1860 (e.g., FPGA 1860) having configurable design 1862. The accelerator 1860 is coupled to memory 1863 (e.g., FPGA DRAM).

The accelerator architecture 1800 provides an automated template discovery with creation and deployment methodology being used to provide additional templates and IP Engines (e.g., bitfiles) for an ever expanding database of template libraries.

In one example, a compiler component of acceleration functionality 1810 identifies and loads FPGA bitstream into FPGA 1860 based on an acceleration template match between an input subgraph and matching acceleration template of the database of templates 1820. The acceleration functionality 1810 then performs a software configuration of the FPGA to customize a hardware template for an application. The acceleration functionality 410 then issues an accelerated input/output and compute operations to move data from the solid-state storage device 1858 to the FPGA memory 1863. Then, the FPGA copies a result of the computation to the application user space by copying the result to host memory 1854.

The present design utilizes smart pattern matching from Application DAG to Hardware Templates with efficient cost functions. DAG template matching algorithms operate on a Directed Acyclic Graph that is typically used in distributed systems like SQL based analytic engines. The DAG template matching algorithms optimally assign the designated slices of the application program to a unique template within a library of templates. The algorithms utilize cost functions (e.g., performance, power, price, locality of data vs. accelerator, latency, bandwidth, data source, data size, operator selectivity based on sampling or history, data shape, etc. . . . ) to assign a slice of DAG to a template. Other standard cost functions can be system or user defined, and can be based on total stage runtime vs task run time. In such cases, part of the graph will execute on the CPU, the rest on the accelerator.

Partial subgraph matches execute on an accelerator based on a cost function that optimizes the system and use either full or partial matches based on run time and historical information. A subgraph matches to a template. A template might include multiple engines. An engine can function as a generic operator or node in the graph. A subgraph might partially match with template. In such cases part of the graph will execute on the CPU, the rest on the accelerator.

Next, the acceleration functionality 410 performs a software configuration of a FPGA to customize a hardware template for an application. The acceleration functionality 1810 then issues an “accelerated” compute task and this requires input/output requests to the device 1858. Input data is copied from a host CPU 1852 to memory of the FPGA 1860 and back again to an application user space memory to complete this process for accelerating big data applications by utilizing acceleration templates.

Field software upgrades provide more operators and functionality enhancements to a current library of an accelerator. Feature discovery for new Engines and Templates happens by profiling the application and accumulating a history of profiles. Next, cost-based targeted optimization is used to realize the highest acceleration opportunities, followed by automated, offline template creation with automatic template library upgrades. Engines can be third party IP or internal IP. For 3rd party IP, the present design can meter to enable charge back.

An accelerator functionality 1810 of the present design is agnostic to the specific physical locality of the FPGA within the overall system architecture. The accelerator functionality can be attached as an add-on card to the host server, embedded into the storage subsystem, or into the network interface, or it can be a remote server/client for near the edge IOT application.

In one example, the accelerator templates comprise a finite set of row-based templates to support most possible sub-graphs (e.g., at least 50% of sub-graphs, at least 80% of sub-graphs, at least 90% of sub-graphs).

In another example, at least one template is used by multiple tenants for software multi-tenancy with a single instance of the application program serving multiple tenants.

The present design shows significant run-time speedup over Apache Spark, based on our row based design. This design can use more SSDs in the system and observes that the performance scales across executors and the smart SSDs. The design can be shown with comprehensive results on columnar formats such as Parquet and ORC. On the hardware side, this design will increase the number of templates available in smart SSDs by including solutions such as DNN and machine learning pipelines, cryptographic and hashing templates, etc. This design may also include pushing the frequency of our kernels along with the number of kernels. On the software side, this design may also include adding support for frameworks like Hive and Kafka to take advantage of our hyper-acceleration layer which now supports smart SSD as well as traditional FPGA architectures.

This design provides a framework for accelerating Big Data platforms on computational storage. This design enables performing computation close to storage and has shown significant query run-time speedup for TPC-DS benchmarks for row-based format on SSD, compared to Apache Spark. These results also scale when moving from single node to multi-node. Apart from higher performance, this design also gains total cost of ownership (TCO) savings when using our accelerated platform on the smart SSD. Two main reasons for TCO saving are: 1) CPU utilization drops dramatically during our accelerated Spark with the smart SSD, specifically during scan stages. This drop leads to shorter tenant run-time and enables more containerized processes in a multi-tenant environment. 2) smart SSD consumes lower power than adding more cores to processor which adds up to a significant amount of energy saving in modern data-centers.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A computer-implemented method for Big Data operations by utilizing subgraph templates for a computational storage device, the method comprising:
performing a query with a dataflow compiler;
performing, with the dataflow compiler, a stage acceleration analyzer function including executing a matching algorithm to determine similarities between sub-graphs of an application program and unique templates from an available library of templates; and
selecting at least one template that at least partially matches the sub-graphs with the at least one template being associated with a linear set of operators to be executed sequentially within a stage of the Big Data operations.

2. The computer-implemented method of claim 1, further comprising:
determining a cost function to determine which linear set of operators to be implemented on a hardware accelerator of the computational storage device.

3. The computer-implemented method of claim 2, wherein the cost function is tuned by profiling of different operators in extract, transform, load (ETL) pipelines and SQL pipelines.

4. The computer-implemented method of claim 1, wherein the at least one template comprises a partially reconfigurable bit file if a hardware accelerator of the computational storage device is a FPGA.

5. The computer-implemented method of claim 4, wherein the at least one template being used by multiple tenants for software multi-tenancy with a single instance of the application program serving multiple tenants.

6. The computer-implemented method of claim 5, wherein the at least one template comprises a finite set of row-based templates to support most possible sub-graphs.

7. The computer-implemented method of claim 1, further comprising:
performing, with a runtime program, a dataflow microarchitecture parameter configuration; and
executing, with the runtime program, a run stage on a hardware accelerator.

8. A computer-readable storage medium comprising executable instructions to cause a processing system to perform operations of distributed multi stage dataflow, the executable instructions comprising:
performing a query with a dataflow compiler of the processing system; and
performing, with the dataflow compiler, a stage acceleration analyzer function including executing a matching algorithm to determine similarities between sub-graphs of an application program and unique templates from an available library of templates, wherein at least one template to support software multi-tenancy with a single instance of the application program serving multiple tenants.

9. The computer-readable storage medium of claim 8, wherein the instructions further comprising:
selecting at least one template that at least partially matches the sub-graphs with the at least one template being associated with a linear set of operators to be executed sequentially within a stage of the multi stage dataflow.

10. The computer-readable storage medium of claim 8, wherein the instructions further comprising:
determining a cost function to determine which linear set of operators to be implemented on a hardware accelerator of a computational storage device.

11. The computer-readable storage medium of claim 10, wherein the cost function is tuned by profiling of different operators in extract, transform, load (ETL) pipelines and SQL pipelines.

12. The computer-readable storage medium of claim 10, wherein the at least one template comprises a partially reconfigurable bit file if the hardware accelerator is a FPGA.

13. The computer-readable storage medium of claim 8, wherein the at least one template comprises a finite set of row-based templates to support most possible sub-graphs.

14. The computer-readable storage medium of claim 8, wherein the instructions further comprising:
performing, with a runtime program, a dataflow microarchitecture parameter configuration; and
executing, with the runtime program, a run stage on a hardware accelerator.

15. A computational storage device comprising:
a solid-state device (SSD); and
a hardware accelerator coupled to the SSD, the hardware accelerator is configured with an acceleration template that is associated with a linear set of operators to form a linear stage trace (LST), to receive control and data information for runtime execution flow by utilizing the acceleration template that is selected from a finite set of templates.

16. The computational storage device of claim 15, further comprising:
memory coupled to the hardware accelerator, wherein the memory and the hardware accelerator are formed on a same board which has a form factor of a PCIe add-in card.

17. The computational storage device of claim 16, wherein the hardware accelerator includes a switch, a direct memory access (DMA) controller, a memory controller to access the memory, a dynamic region, and embedded processor cores.

18. The computational storage device of claim 17, wherein the computational storage device supports a normal mode and a Peer-to-Peer (P2P) mode of data transfer.

19. The computational storage device of claim 18, wherein during the normal mode, a read or write operation is issued by a host and data is transferred between the solid-state device and a host memory through the switch, which comprises a three-way switch.

20. The computational storage device of claim 18, wherein during the P2P mode, data is transferred from the solid-state device to the memory of the computational rage device for processing by a local peered device.

21. The computational storage device of claim 18, wherein a P2P command queue from is decoupled from a compute command queue.

22. The computational storage device of claim 21, wherein the P2P mode to use asynchronous read for P2P as opposed to synchronous read so that a single thread can operate on both P2P and compute command queue.
